(19) United States
(12) Patent Application Publication
(10) Pub. No.: US 2023/0394295 A1
(43) Pub. Date: Dec. 7, 2023

(54) SUPERVISED CONTRASTIVE LEARNING FOR RELATED CONTENT RECOMMENDATION

(71) Applicant: Microsoft Technology Licensing, LLC, Redmond, WA (US)

(72) Inventors: Chu WANG, Bellevue, WA (US); Rui XIA, Burnaby (CA); Zhiting CHEN, Bellevue, WA (US); Li HUANG, Sammamish, WA (US); Kun WU, Bellevue, WA (US); Andrew Lawrence STEWART, Ottawa (CA); Hanmu ZUO, Toronto (CA); Meenaz MERCHANT, Kirkland, WA (US); Kamal GINOTRA, Kirkland, WA (US); Saurajit MUKHERJEE, Kirkland, WA (US); Arun K. SACHETI, Sammamish, WA (US); Tingting WANG, Bellevue, WA (US)

(73) Assignee: MicrosoftTechnology Licensing, LLC, Redmond, WA (US)

(21) Appl. No.: 17/805,262

(22) Filed: Jun. 3, 2022

(51) Int. Cl. G06N 3/08; G06K 9/62; G06N 3/04

(52) U.S. Cl. CPC G06N 3/08; G06K 9/6251; G06K 9/6256; G06N 3/04

(57) ABSTRACT

Aspects of the present disclosure relate to a providing related content recommendations in response to a user search query by supervising the training of pair embeddings using contrastive learning and pairwise co-click signals. The approach combines a two tower model architecture with a cascaded multilayer perceptron model to enable the adoption of variable combinations of input features and more representative learned pair embeddings. The learned embeddings undergo supervised contrastive loss training to generate a related content recommendation model, which is subsequently evaluated using both online and offline metrics. The related content recommendation model can provide results to search queries that improve recommendation quality and increase user engagement, thereby ultimately enhancing long term user experience.

### BACKGROUND

Related content recommendation has become an important part in modern life with the increasing prevalence of internet search and recommendation platforms. Unfortunately, the combination of providing relevant related content recommendations which are also varied and engaging to the user is a challenging task. For example, recommendations based on semantic context alone may return results lacking diversity, that in turn may cause a user to lose interest in the search and possibly the search platform itself.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a providing related content recommendations in response to a user search query by supervising the training of pair embeddings using contrastive learning and pairwise co-click signals. The approach combines a two tower model architecture with a cascaded multilayer perceptron model to enable the adoption of variable combinations of input features and more representative learned pair embeddings. The related content recommendation model undergoes supervised contrastive loss training to generate learned embeddings, and the model is subsequently evaluated using both online and offline metrics. The related content recommendation model can provide results to search queries that improve recommendation quality and increase user engagement, thereby ultimately enhancing long term user experience.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 illustrates an overview of an example system for recommending related content in response to a user search query.

FIG. 2 illustrates an overview of an example method for recommending related content based on a user search query.

FIG. 3 illustrates an overview of an example method for modeling joined feature vectors using a single cascaded multilayer perceptron (MLP) neural network.

FIG. 4 is an example user interface of a result from a search query with recommended related content.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, individuals rely upon online search platforms to produce results to search queries about various topics. In addition to initial results based upon a search query, search platforms and recommender systems may generate related content recommendations in response to the user query. The related content recommendations provide additional information on similar topics, which the user may choose to explore. The task of related content recommendation may involve the recommender system proposing related items to a given query or else risk losing user engagement with the platform. For example, when a user is browsing an image, the recommender system may generate a set of related images to provide to the user. The goal of such recommendation is to improve user engagement within both the recommender system and within the broader context of the search query as compared to alternate content recommendation systems. Other approaches may employ pretrained convolutional neural network features or pretrained page level language embeddings to generate visually and/or semantically similar items in response to the search query. Consequently, the results returned in response to the search query may tend to provide a monotone and boring user experience that is underinclusive of content that may otherwise be considered relevant by the user.

Accordingly, aspects of the present disclosure relate to recommending related content in response to a user search query. The approach aims to train the recommender system via supervision of image and page pair embeddings using pairwise co-click signals. As used herein, a co-click signal may associate an instance of content with which a user has interacted (e.g., by clicking or tapping on the content, zooming in on the content, etc.) with content that is responsive to a search query, thereby indicating that the instance of content is a “positive pair” in relation to the responsive content. Conversely, a co-click signal may be used to identify a “negative pair” for an instance of content with which a user does not interact. Pairwise co-click signals improve image recommendation quality and user engagement to improve user experience by generating suggested content based on quantifiable user feedback. By relying on previously selected content to generate new suggestions, the model produces results with a higher probability of engaging the user. More specifically, the approach utilizes supervised contrastive loss learning to guide the supervision process and improve recommendation quality. In aspects, a two-tower model is applied in conjunction with a cascaded multilayer perceptron (MLP) model to enable adoption of variable combinations of input features resulting in more representative learned embeddings. The approach ties the supervised contrastive learning targets to improving user engagement, which produces positive results over both the short-term and long-term. Following the supervision process, the user receives tailored related content results. In some examples the results may be user specific or they may be based off generalized results. The improved model provides relevant recommendations to the user to maximally increase user engagement.

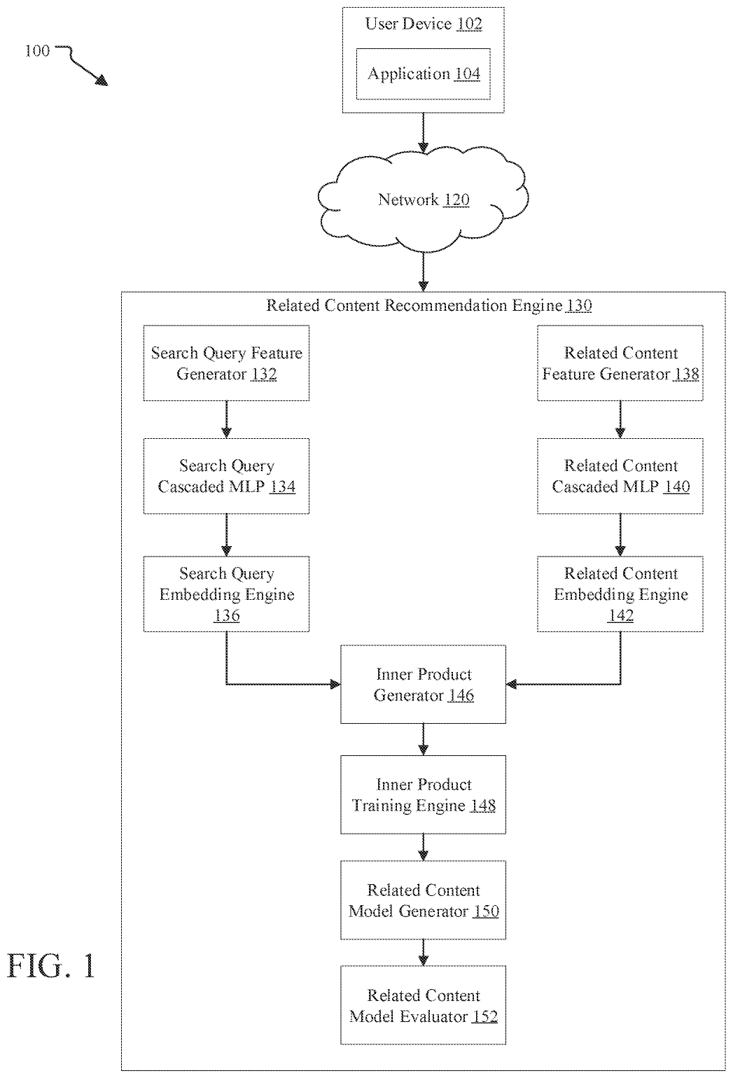

FIG. 1 illustrates an overview of an example system 100 for recommending related content in response to a user search query according to aspects described herein. As illustrated, system 100 comprises a user device 102, application 104, network 120 and related content recommendation engine 130. In examples, user device 102 and related content recommendation engine 130 communicate via network 120, which may comprise a local area network, a wireless network, or the Internet, or any combination thereof, among other examples.

User device 102 may be any of a variety of devices, including, but not limited to, a desktop computer, laptop computer, a tablet, and a wireless device. In examples, the application 104 is an application on the user device 102 that displays content for use on the user device 102 and communication across the network 120. Application 104 may be a native application, a web-based application, or any combination thereof, among other examples. Application 104 may operate substantially locally to user device 102 or may operate according to a server/client paradigm in conjunction with one or more servers (e.g., related content recommendation engine 130 and/or any of a variety of other servers, not pictured). In certain aspects, application 104 may be an application that includes or otherwise accesses a search function with which a search query may be used to obtain a list of results that includes content related to the search query. The search query may include and/or be for any of a variety of content, including, but not limited to, text, a document, image content, video content, news, a web site, a web address, and/or shopping products or information. For example, a textual search query may be used to obtain image content that is responsive to the search query. It should be appreciated that the described list of potential search queries is not exhaustive and that a search query may include any type of content that can be accessed or otherwise obtained by the related content recommendation engine 130. In examples, a search query may be initiated by the user on the application 104 in a variety of ways, including, but not limited to, entry of text and/or image content (among other examples) into a search field or as a user selection of an image or a link displayed on the application.

The related content recommendation engine 130 may receive the search query via the network 120 (e.g., from application 104) and process it to generate related content that can be returned to the user device 102 via the network 120 for display and/or selection in the application 104. The related content recommendation engine 130 is illustrated as comprising a search query feature generator 132, search query cascaded MLP 134, search query embedding engine 136, related content feature generator 138, related content cascaded MLP 140, related content embedding engine 142, inner product generator 146, inner product training engine 148, related content model generator 150, and related content model evaluator 152.

In examples, the related content recommendation engine 130 may receive the user search query from the network 120. The related content recommendation engine 130 may utilize a two-tower approach, one machine learning tower for representation learning of the search query and another machine learning tower for the related content response to the search query (e.g., including possible related content that may be recommended by the system). Thus, each tower may have an associated content type in some examples. Each tower may be designed as a cascaded MLP model that transforms the input feature vectors into a learned representation embedding for related content recommendation. An example two-tower approach is shown in FIG. 1, with one tower for the search query illustrated as comprising search query feature generator 132, search query cascaded MLP 134, and search query embedding engine 136, while the other tower for the related content is illustrated as comprising related content feature generator 138, related content cascaded MLP 140, and related content embedding engine 142. The two-tower model for the related content recommendation engine 130 is beneficial, because the set of input features processed by each tower may vary, such that there is a different set of features for the search query tower as compared to a set of features for the related content tower, as will be described below. It will be appreciated that the sets of features need not be mutually exclusive. While the description below begins with the search query tower first, it should be appreciated that the order of system operation can function equally well with either tower being processed first, both towers being processed simultaneously, or by some other order which retains the linear nature of each tower as a prerequisite.

Beginning with the search query tower of the two-tower model, the search query feature generator 132 receives or otherwise obtains raw input features associated with a search query (e.g., as may be received over the network 120). The content type associated with the nature of the raw input features may vary based on the type of search query provided by the user. In aspects, the raw input feature may be a high-dimensional unlabeled input dataset including a multitude of features. For example, if the search query was associated with an image search, the raw input features may include features such as a text query (e.g., text embeddings), image features (e.g., vision embedding, optical character recognition, attractiveness, etc.), page features (e.g., page title, surrounding text, etc.), and context features (e.g., user information, device information, timestamp, location, language, etc.).

The high-dimensional raw input may utilize pre-processing to discover low-dimensional signature features that capture its underlying structure. In instances, the process of generating low-dimensional features may utilize feature scaling, centering, and/or dimensionality reduction. Feature scaling may be conducted in several ways, including, but not limited to, absolute maximum scaling, min-max scaling, normalization, standardization, and/or robust scaling. Dimensionality may be reduced using one or more feature selection techniques, including, but not limited to, missing value ratio, low variance filter, high correlation filter, random forest, backward feature elimination and forward feature selection. Additionally or alternatively, dimensionality may be reduced based on factor techniques, including, but not limited to, factor analysis, principal component analysis, independent component analysis, or by projection-based dimensionality reduction techniques (e.g., including t-distributed stochastic neighbor embedding, ISOMAP and UMAP). Once the pre-processing is complete, the features may be gathered and/or concatenated into a search query joined feature vector.

The search query joined feature vector from search query feature generator 132 is processed according to the search query cascaded MLP 134. in an example, the search query cascaded MLP 134 is a feedforward neural network connecting multiple layers in a directed graph, such that the signal path through the nodes transits in a single direction to facilitate training the model features. The search query cascaded MLP 134 begins with input data from the joined feature vector that is fed into the first MLP layer. A cascaded MLP is one in which multiple MLP layers are stacked and processed to achieve an appropriately sized output from the input vectors. At each layer of the MLP, the input may be expanded or bottlenecked. If the input is expanded, complexity is added to the input and then output to the next layer. If the input is bottlenecked, the input is instead condensed, such that the reduced final output is a vector to utilize for retrievals. In aspects, the first MLP layer could be an expand layer while later layers could be bottlenecks. Between MLP layers, data scaling may occur. For example, data scaling methods including data normalization (e.g., batch normalization, activation, dropout) or data standardization may be applied to the output of each layer of the cascaded MLP to prepare it for input to the next cascaded MLP layer. Batch normalization may include standardizing outputs from various neurons within the neural network in preparation for input to another layer of the MLP. Activation may add non-linearity to the computation, thereby increasing complexity of the cascaded MLP model and of the input data for subsequent MLP layers. Dropout may avoid or reduce the potential for over-fitting between layers by ignoring or dropping out certain layers output as a subsequent input to the next MLP layer, thus reducing the size of the model at the next MLP layer. In aspects, the cascaded MLP may also employ skip connections between the initial input and other subsequent cascaded MLP layers, such that one or more input gradients may pass directly to subsequent layers without being processed by previous MLP layers. If skip connections are utilized, the training process may be significantly accelerated in some instances. In examples, the cascaded MLP may have a structure, such that there is an input followed by the first MLP layer, which may expand the input. Then, a batch normalization may occur which is input into a second MLP layer to bottleneck the input, followed by another batch normalization and so on through successive MLP layers. Skip connections may occur throughout the MLP (e.g., between two layers) to speed the training process in determining the trained joined feature vector for the search query as a final output of the cascaded MLP.

The search query response final output (e.g., from search query cascaded MLP 134) is sent or otherwise provided to the search query embedding engine 136, so that the relationship between the categories of the output may be expressed as an embedded vector. For example, the embedding may capture similar inputs close together in the embedding space, which can then be learned and reused subsequently or across various models. The search query embedding engine 136 may generate a link, where one or more relationships between similar items to the initial search query may be passed to the related content model to generate related content recommendations (e.g., by inner product generator 146). Thus, the search query embedding may be one half of the pair embedding that are used by the inner product generator 146, while the other half of the pair embedding may be generated by the related content tower (e.g., elements 138, 140, and 142) of the two-tower model.

While the search query tower is processing the search query embedding, the related content tower functions in a similar way. Initially, the related content feature generator 138 receives raw input features for the related content over the network 120. The nature of the raw input features varies based on the type of search query initiated by the user. In aspects, the raw input feature may be a high-dimensional unlabeled input dataset including a multitude of features. For example, if the search query was an image search the raw input features for the related content tower could include features such as text query (e.g., text embeddings), image features (e.g., vision embedding, optical character recognition, attractiveness, etc.), page features (e.g., page title, surrounding text, etc.), and context features (e.g., user information, device information, timestamp, location, language, etc.). The high-dimensional dataset may utilize pre-processing to generate low-dimensional features which capture the underlying structure of the raw input. In instances, the process of generating low-dimensional features may also utilize feature scaling, centering and/or dimensionality reduction. Feature scaling may be conducted in several ways including absolute maximum scaling, min-max scaling, normalization, standardization and/or robust scaling. Dimensionality can be reduced in a variety of ways including but not limited to feature selection techniques including missing value ratio, low variance filter, high correlation filter, random forest, backward feature elimination and forward feature selection. Additionally or alternatively, dimensionality may be reduced based on factor techniques including factor analysis, principal component analysis, independent component analysis or by projection-based dimensionality reduction techniques including t-distributed stochastic neighbor embedding, ISOMAP and UMAP. Once the pre-processing is complete the features are gathered and concatenated into a related content joined feature vector.

The related content joined feature vector is input into the related content cascaded MLP 140. The related content cascaded MLP 140 is a feedforward neural network connecting multiple layers in a directed graph such that the signal path through the nodes transits in a single direction only to facilitate training the model features. The related content cascaded MLP 140 may begin with input data from the joined feature vector that is fed into the first MLP layer. A cascaded MLP is one in which multiple MLP layers are stacked and processed to achieve an appropriately sized output from the input vectors. At each layer of the MLP the input may be expanded or bottlenecked. If the input is expanded it means complexity is added to the input and then output to the next layer. If the input is bottlenecked the input is condensed such that the reduced final output is a vector to utilize for retrievals. In aspects, the first MLP layer could be an expand layer while later layers could be bottlenecks. Between MLP layers data scaling may occur. Data scaling methods such as data normalization (e.g., batch normalization, activation, dropout) or data standardization are applied to the output of each layer of the cascaded MLP to prepare it for input to the next cascaded MLP layer. Batch normalization may include of standardizing outputs from various neurons within the neural network in preparation for input to another layer of the MLP. Activation adds non-linearity to the computation to increase complexity to the cascaded MLP model to achieve more complicated input data for subsequent MLP layers. Dropout avoids the problem of over-fitting between layers by ignoring or dropping out certain layers output as a subsequent input to the next MLP layer, thus reducing the size of the model at the next MLP layer. In aspects, the cascaded MLP may also employ skip connections between the initial input and other subsequent cascaded MLP layers such that input gradients may pass directly to subsequent layers without being processed by previous MLP layers. If skip connections are utilized the training process may be significantly accelerated, in some instances. In examples, the cascaded MLP may have a structure, such that there is an input followed by the first MLP layer, which may expand the input. Then a batch normalization may occur which is input into a second MLP layer to bottleneck the input, followed by another batch normalization and so on through successive MLP layers. Skip connections may occur throughout the MLP between each layer to speed the training process in determining the trained joined feature vector for the search query as a final output of the cascaded MLP.

The related content final output is sent to the related content embedding engine 142 so that the relationship between the categories of the output can be expressed as an embedded vector. The embedding may capture similar inputs close together in the embedding space which can then be learned and reused subsequently or across various models. The related content embedding creates a link where relationships between similar items to the initial search query can be utilized to generate related content recommendations. Thus, the related content embedding becomes one half of the pair embedding that is sent to the inner product generator 146, along with the search query embedding discussed above.

At the inner product generator 146, the results of each half of the two towers (e.g., as may be generated by search query embedding engine 136 and related content embedding engine 142) are used to generate an inner product, which may be a single untrained combination of search query and related content. In instances, the inner product may have multiple related instances of content, which may be offered in association with a search query as a set of content recommendations for the initial search. For example, if an initial search query was for images of a golden retriever puppy, that search query may be paired with a variety of images corresponding to the features and embeddings derived from the related content tower. In this instance, the related content portion of the inner product may include a variety of candidate images related to golden retriever puppies (e.g., just the golden retriever puppy, a running golden retriever puppy, a group of golden retriever puppies, etc.).

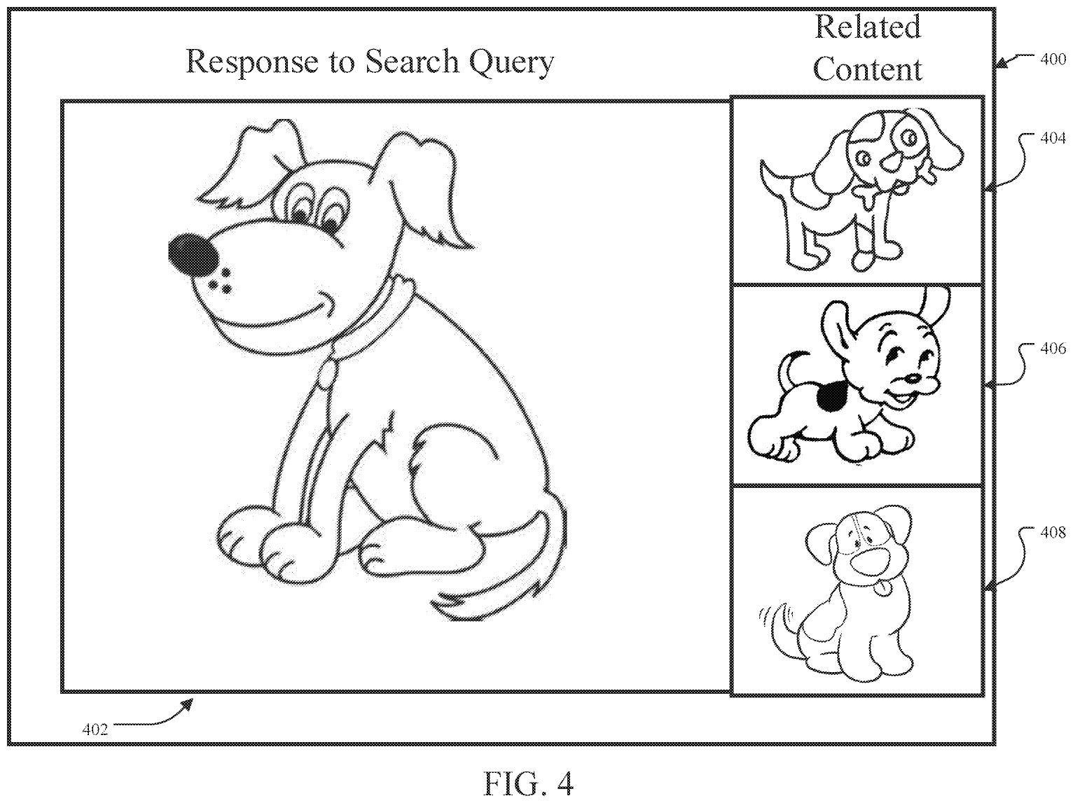

The inner product may be used to perform supervised training at the inner product training engine 148. As an example, the inner product training engine 148 employs self-supervised representation learning during training. In instances, either generative or discriminative methods may be employed. If discriminative methods are employed for training, they may be, for example, auxiliary task or contrastive loss. In instances, supervised contrastive loss is employed to train the model by tracking the results of pairwise co-click signals of user selected related content from the untrained inner product. The pairwise co-click process involves contrasting the user selected positive inner product pairs against the large dataset of negative inner product pairs based on a user's co-click signals from the related content options presented to the user. FIG. 4 is an example of the user interface which may be presented to the user. Related content candidate pairs may thus be provided for display to a user in response to a search query received from the user's device. For example, the related or recommended content may be presented in association with content that is responsive to the user's search query (e.g., as may be identified by a content recommendation engine or by another computing device). The user may select one of the offered related content pairs, such that the user selection may be stored for subsequent processing. Thus, a positive pair indicates related content that was selected by the user. Negative pairs are the unselected instances of related content.

Over multiple iterations, the contrastive loss supervised training techniques described herein may be used to generate a result set of high-scoring positive pairs and low-scoring negative pairs based on user selection (e.g., based on one or more co-click signals as described above). A high-scoring positive pair is an inner product combination that has been selected many times (e.g., above a predetermined threshold) during the pairwise co-click signals training process, and may thus strongly suggest or otherwise indicate a relationship exists between the two images or other types of content. Conversely, a low-scoring negative pair may be an inner product combination that was selected less often during training (e.g., below a predetermined threshold), thus strongly suggesting or otherwise indicating a weak or no relationship exists between the images or other content. By comparing the high-scoring positive pairs to the low-scoring negative pairs, comparatively highly correlated related content can be determined (e.g., as may be provided as recommended content according to aspects described herein).

The goal of the contrastive loss training is to let the signal strength of the positive pairs become prominent in comparison to the large dataset of low-scoring negative pairs over multiple learning iterations. In this way, after the learning process converges, the contrastive loss training may generate high-scoring positive pairs that are highly related to the initial search query. Conversely, the large dataset of negative pairs may generate low scores indicating the pair is unrelated to the initial search query. By contrasting the differences between high and low scoring related content pairs, the contrastive loss via pairwise co-click signals optimizes user engagement in training a related content model for the system. To avoid noise in the co-click signal responses, one or more post-processing techniques may be employed to filter out response pairs. Post-processing techniques may include, but are not limited to, avoiding or omitting adult content, as well as evaluating soliciting user input (e.g., from one or more human judges) and utilizing thresholds, such that co-click pairs that have been selected (e.g., as a positive pair or negative pair) above or below a predetermined threshold may be used for processing according to the aspects described herein.

As an example, let a positive pair collected from the co-click signals be represented as (i, j), and let

$$f ( u , v ) = \frac{ν * {u}^{T}}{‖ u ‖ * ‖ ν ‖}$$

represent a cosine similarity metric between embedding vectors u and v. In such an example, the contrastive loss for pair (i, j) may be defined as the following equation:

$${L}_{i , j} = - log \frac{exp ( f ( \frac{{z}_{i} , {z}_{j}}{τ} ) )}{{\sum }_{k \neq i} exp ( f ( \frac{{z}_{i} , {z}_{j}}{τ} ) )}$$

The denominator of the above equation is comprised of negative pairs, where the search query response zᵢ does not exhibit a positive relation to the related content based on the co-click signals. Over many training iterations, the resulting positive pairs and negative pairs may produce a record of high-scoring positive pairs and low-scoring negative pairs. It will be appreciated that the above equation is provided as an example and, in other examples, any of a variety of alternative equations may be used.

The related content recommendation model is generated by the related content model generator 150. The trained model parameters generated by the inner product training engine 148 may be utilized by related content model generator 150 to generate a model candidate and compute feature vectors. The feature vectors may be computed using the trained model parameters in conjunction with neural network architecture. The related content recommendation engine may thus apply the computed feature vectors to the ranking algorithm to recommend related content to the user in response to a search. The resulting related content recommendation model may thus be available for use by related content recommendation engine 130 according to aspects described herein. The high-scoring positive pairs, from training, may become a template of feature vectors for the model to apply to user search queries when generating related content recommendations. Likewise, the low-scoring negative pairs, from training, may become a template of feature vectors for the model to disregard or remove in response to user search queries when generating related content recommendations. In other words, after the learning process converges, the related content model generated by related content model generator 150 will be able to generate a high score if a piece of content is highly related to a given search query, whereas the related content model will generate a low score if a piece of content is not highly related to the search query.

The related content model is evaluated by the related content model evaluator 152. Generally, the related content model is evaluated by applying the model to user search queries (e.g., as may be received from user device 102), generating ground-truth next click predictions for the search query, recording the results of the users next click and comparing the results to the predictions to see if the prediction was correct. To evaluate the effectiveness of the trained related content model, both offline metrics and/or online metrics may be utilized.

Examples of offline metrics that may be employed singularly or in combination with other offline or online metrics include, but are not limited to, precision, top K retrieval recall, fall-out, F-score, average precision, defect rate, precision at k, R-precision, mean average precision and/or discounted cumulative gain. For example, top K retrieval recall may be employed to reflect how many ground truth targets the related model correctly predicted within the top K ranked candidates, when computed against a moderately sized dataset. In this example, the typical choice of dataset volume is 1 million related content pairs and K may range from 5 to 200. Further, after completing the evaluation using top K retrieval recall and acquiring a reasonable related content model, a human judge-based evaluation metric may be applied known as defect rate. The defect rate metric tracks the number of defect items in the top recommended results from the related content model, based upon the opinion of trained human judges. The size of top results considered may vary based on the volume of data to be evaluated. The defect rate aims to provide a close approximation to the true performance of the trained model, that is unbiased from co-click signals' noise.

Examples of online metrics that may be employed singularly or in combination with other online or offline metrics include, but are not limited to, click-through rate, online A/B test, session success rate and/or zero result rate. For example, after acquiring the two offline metrics for the model described above, an online A/B test may be performed on the related content model. During this test, two flights are constructed. The first flight A is a control flight that uses the baseline approach of the current production model to generate results to a search query. The second flight B is the treatment flight which uses the best related content model selected from the offline metric benchmarks to generate results to a search query. Substantially equal traffic is directed between the two flights and the A/B test run is conducted for a certain amount of time. At the conclusion of the test, a scorecard demonstrating the performance difference between the control flight A and treatment flight B is generated. The scorecard may include a variety of performance metrics comparing the two flights including but not limited to click-through rate, unique user percentages with related content clicks and number of clicks per unique user. The results of the scorecard may validate the related content model or highlight inefficiencies in the model which may need to be addressed through subsequent training. The evaluated related content model may then be utilized to provide recommendations of related content in response to user search queries via the network 120 communicating recommended related content to the user device 102.

As will be appreciated, the various methods, devices, apps, nodes, features, etc., described with respect to FIG. 1 or any of the figures described herein, are not intended to limit the system to being performed by the particular apps and features described. For example, multiple user devices and/or related content recommendation engines may be used. As another example, related content recommendation engine 130 may generate content recommendations for another computing device (e.g., as may be requested and/or provided via an application programming interface (API), among other examples). Accordingly, additional configurations may be used to practice the methods and systems herein and/or features and apps described may be excluded without departing from the methods and systems disclosed herein.

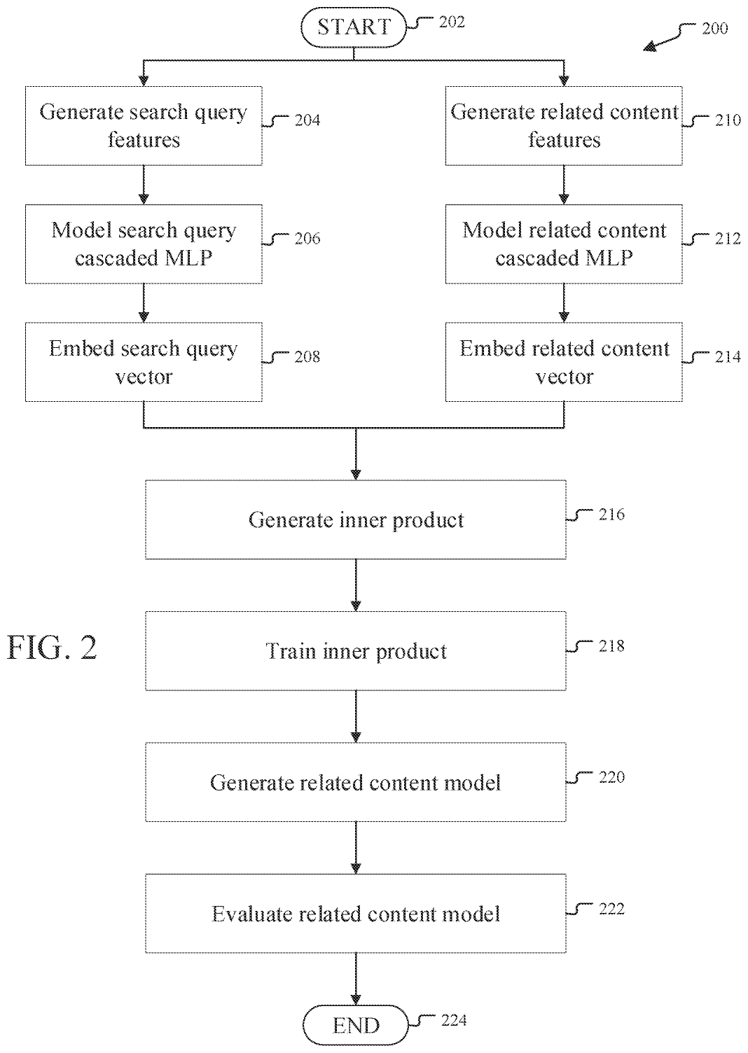

FIG. 2 is an example of a method 200 for recommending related content based on a user search query. A general order of the operations for the method 200 is shown in FIG. 2. Generally, the method 200 begins with start operation 202 and ends with end operation 218. The method 200 may include more or fewer steps or may arrange the order of the steps differently than those shown in FIG. 2. The method 200 can be executed as computer-executable instructions executed by a computer system and encoded or stored on a computer readable medium. Further, the method 200 can be performed by gates or circuits associated with a processor, an ASIC, an FPGA, a SOC or other hardware device. Hereinafter, the method 200 shall be explained with reference to the systems, components, devices, modules, software, data structures, data characteristic representations, signaling diagrams, methods, etc., described in conjunction with FIGS. 1, 3, 4, 5, 6A, 6B, and 7.

Following the start operation 202, the method 200 continues with the generate operation 204, which generates search query features from the input data (e.g., which may be based on a search query, as may be received from a user device, such as user device 102). The generate operation is the first step in the search query tower (e.g., operations 204, 206, and 208) of the two-tower cascaded MLP model. The input data may be a high-dimensional dataset that may utilize pre-processing to discover low-dimensional features which capture the underlying structure of the search query. In instances, the pre-processing may also utilize feature scaling, centering and/or dimensionality reduction. Once the pre-processing is complete, the features are gathered and concatenated into a search query joined feature vector.

At operation 206, the search query is modeled as a cascaded MLP (e.g., as may be generated by search query cascaded MLP 134). At each layer of the MLP the input may be expanded or bottlenecked. Between MLP layers, data scaling may occur, including, but not limited to, data normalization (e.g., batch normalization, activation, dropout) and/or data standardization. The cascaded MLP may also employ skip connections between the initial input and other subsequent cascaded MLP layers such that input gradients may pass directly to subsequent layers without being processed by previous MLP layers.

Flow progresses to operation 208, where the search query vector is embedded. For example, utilizing the output of the cascaded MLP model (e.g., as was generated at operation 206), the embed operation may transform the input feature vectors into a learned representation embedding that is specialized for subsequent related content recommendation. Flow then progresses to operation 216, which is discussed below.

The generate operation 210, where related content features from the input data are generated. As illustrated, operation 210 is the first operation in the related content tower of the two-tower cascaded MLP model (e.g., comprised of operations 210, 212, and 214). The input data may be a high-dimensional dataset (e.g., which may be based on a search query, as may be received from a user device, such as user device 102), that may utilize pre-processing to discover low-dimensional features which capture the underlying structure of the input data. In instances, the pre-processing may also utilize feature scaling, centering and/or dimensionality reduction. Once the pre-processing is complete the features may be gathered and concatenated into a related content joined feature vector.

At operation 212, the related content is modeled as a cascaded MLP (e.g., as may be generated by related content cascaded MLP 140). At each layer of the MLP the input may be expanded or bottlenecked. Between MLP layers data scaling may occur including but not limited to data normalization (e.g., batch normalization, activation, dropout) and/or data standardization. The cascaded MLP may also employ skip connections between the initial input and other subsequent cascaded MLP layers such that input gradients may pass directly to subsequent layers without being processed by previous MLP layers.

Flow progresses to operation 214, where the related content vector is embedded. Utilizing the output of the cascaded MLP model (e.g., as was generated at operation 212), the embed operation transforms the input feature vectors into a learned representation embedding which is specialized for subsequent related content recommendation.

At operation 216, an inner product is generated from the search query vector (e.g., as was generated at operation 208) and related content vector (e.g., as was generated at operation 214). While method 200 is illustrated as performing operations 204, 206, and 208 contemporaneously with operations 210, 212, and 214, it will be appreciated that, in other examples, at least some operations may be performed sequentially or according to any of a variety of other orderings. The inner product may be a single untrained combination of search query and related content. In instances, the inner product may have multiple related content offered in combination with the search query as candidate related content recommendations for the initial search.

At operation 218, the inner product is trained (e.g., as may be performed by inner product training engine 148 discussed above with respect to FIG. 1). For example, supervised contrastive loss may be employed to train the model by tracking the results of pairwise co-click signals of user selected related content from the untrained inner product. The pairwise co-click process may involve contrasting the user selected high-scoring positive inner product pairs against the large dataset of low-scoring negative inner product pairs. The results produce highly correlated related content recommendations in response to a search query.

Flow progresses to operation 220, where a related content model is generated based on the supervised training results of operation 218. For example, a set of high-scoring positive pairs may become a template of feature vectors for the model to apply to user search queries when generating related content recommendations. Likewise, a set of low-scoring negative pairs may become a template of feature vectors for the model to disregard or remove in response to user search queries when generating related content recommendations. The resulting related content recommendation model may thus be available for use according to aspects described herein (e.g., by a related content recommendation engine, such as related content recommendation engine 130 discussed above with respect to FIG. 1).

At operation 222, the related content model is evaluated. For example, the related content model is evaluated by applying the model to user search queries, generating ground-truth next click predictions for the search query, recording the result of the user's next click (e.g., a positive and/or negative interaction with recommended content), and/or comparing the result to the predictions to see if the prediction was correct. To evaluate the effectiveness of the trained related content model both offline metrics and/or online metrics may be utilized. Method 200 ends at operation 224.

Although the method 200 as described above begins with operation 202 then to operation 204, the operation 202 may be followed by either the generate operation 204 or the generate operation 210. The method 200 includes a two-tower cascaded MLP represented by steps 204 through 214. Steps 204 through 208 represent the search query tower while steps 210 through 214 represent the related content tower. The steps of either tower may be performed sequentially as described above and/or in any other order which maintains the functionality and linear input to output flow of each tower. In this regard it is contemplated that the steps of each tower may occur simultaneously such that step 204 and 210 occur simultaneously and so on through steps 208 and 214. Likewise, they may occur such that step 210 occurs first followed sequentially to step 214 then to step 204 through step 208 or they may occur in some other order based on user preferences.

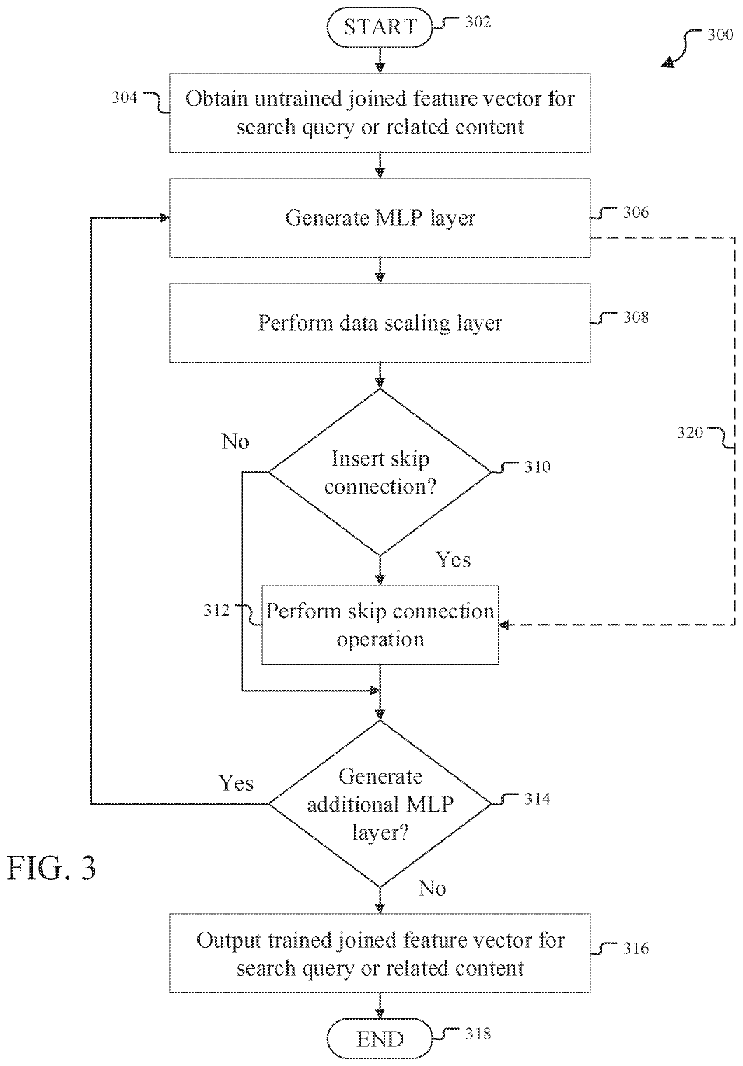

FIG. 3 is an example of a method 300 for modeling joined feature vectors using a single cascaded MLP neural network. A general order of the operations for the method 300 is shown in FIG. 3. Generally, the method 300 begins with start operation 302 and ends with end operation 318. The method 300 may include more or fewer steps or may arrange the order of the steps differently than those shown in FIG. 3. The method 300 may be performed as a single tower cascaded MLP or utilized in conjunction with other cascaded MLP in a multiple towers model as described above. In examples, aspects of method 300 may be performed as part of operation 206 and/or operation 212 discusses above with respect to method 200 of FIG. 2. The method 300 can be executed as computer-executable instructions executed by a computer system and encoded or stored on a computer readable medium. Further, the method 300 can be performed by gates or circuits associated with a processor, an ASIC, an FPGA, a SOC or other hardware device. Hereinafter, the method 300 shall be explained with reference to the systems, components, devices, modules, software, data structures, data characteristic representations, signaling diagrams, methods, etc., described in conjunction with FIGS. 1, 2, 4, 5, 6A, 6B, and 7.

Following the start operation 302, the method 300 continues with operation 304, where a joined feature vector is obtained for either the search query or related content tower. The joined feature vector may be the result of pre-processing the raw input dataset to discover low-dimensionality features that can be applied to the feedforward MLP neural network to discover feature embeddings.

At operation 306, an MLP layer within the cascaded MLP neural network is generated. For example, each layer of the cascaded MLP the input may be expanded or bottlenecked. If the input is expanded, complexity is added to the input and then output to the next layer. If the input is bottlenecked, the input is condensed such that the final output becomes a reasonable sized vector to utilize for retrievals.

Flow progresses to operation 308, where one or more data scaling operations are performed on the output of the previous MLP layer. Data scaling methods, such as data normalization (e.g., batch normalization, activation, dropout) or data standardization, are applied to the output of each layer of the cascaded MLP to prepare it for input to the next cascaded MLP layer.

At determination 310, it is determined whether a skip connection should be inserted in the method. A skip connection may be utilized to facilitate direct gradient backward passage within the neural network. The benefit of introducing a skip connection is that it allows earlier MLP layers of a deep neural network to be trained more directly with the loss gradients of a later MLP layer, which may decrease the amount of time to parameter convergence. One or more skip connections may be introduced based on the design characteristics and/or the complexity of the scenario. For example, determination 310 may comprise determining to insert a skip connection as the number of cascaded MLP layers increases above a predetermined threshold (e.g., 20 or more layers), thereby decreasing the amount of time to parameter convergence. If it is determined not to insert a skip connection, the method branches “No” and proceeds to determination 314, which is discussed below.

Alternatively, if it is determined to insert a skip connection, the method branches “Yes” and proceeds to operation 312, where a skip connection operation is performed. At operation 312, the output from operation 308 and the output from operation 306 (e.g., as indicated by dashed arrow 320) may be combined (e.g., using element-wise addition) to create an output vector. The output vector may be utilized as the input for subsequent MLP layers at operation 306. Flow then progresses to determination 314.

At determination 314, it is determined whether an additional MLP layer should be generated. Additional MLP layers may be generated if a more complex model is desired. In examples where the variance in user behavior and training data is comparatively large, additional MLP layers may be generated to account for such complexity. As an example, the greater the scenario complexity, the more likely it is that a deeper neural network (e.g., with additional cascaded MLP layers) is needed to produce accurate recommendations. Conversely, in situations where the scenario is comparatively less complex, a shallow neural network with fewer cascaded MLP layers may be utilized and may still produce accurate recommendations in such a scenario.

If it is determined that an additional MLP layer is to be generated, the method branches “Yes” and returns to operation 306, where an additional MLP layer will be generated as described above. If no skip connection is inserted, the input to operation 306 may be the output from operation 308. Alternatively, if a skip connection is inserted the input to operation 306 may be the output of the element wise addition from operation 312. If it is determined not to generate an additional MLP layer, flow instead branches “No,” such that the cascaded MLP training is complete and the method progresses to output operation 316, which outputs the trained joined feature vector for either the search query or related content that results from the cascaded MLP. Method 300 ends with end operation 318.

FIG. 4 is an example user interface of a result from a search query with recommended related content. User interface 400 is an example of what could be presented to a user as a related content web interface (e.g., as may be utilized in a pairwise co-click training session or when a user is searching for content). In this example, the initial search query was for an image of a dog. The center image 402 may be content that is responsive to a user's initial search query. The side images 404, 406 and 408 are candidate related content recommendations (e.g., as may have been generated according to aspects described herein, for example by a model as the other half of the inner product). Each of the images 402, 404, 406, and/or 408 may be selected by the user. When a user selects a side image of related content, for example image 406, the selected image may be used as a positive pair indicating a potential positive relationship between the center image and the selected related content. Conversely, the remaining unselected images (e.g., images 404 and 408) may be used as negative pairs that indicate there is likely not a positive relationship between the center image and the unselected content. Over multiple iterations (e.g., by the same user or among multiple users), the contrastive loss supervised training may generate a result set of high-scoring positive pairs and low-scoring negative pairs based on user selection. By comparing such high-scoring positive pairs and low-scoring negative pairs, highly correlated related content can be determined according to aspects described herein.

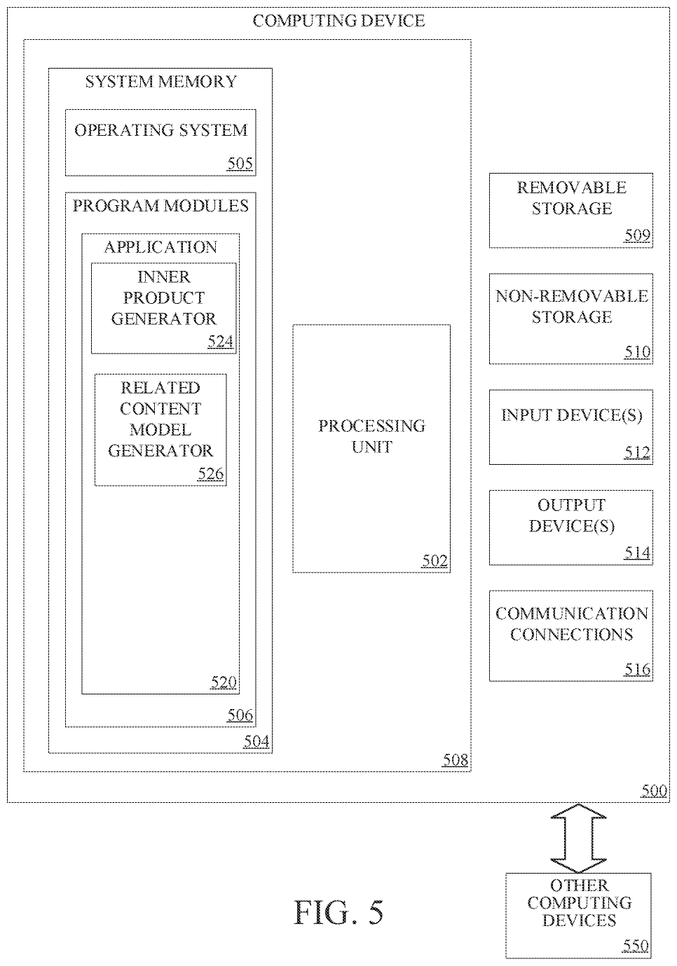

FIG. 5 is a block diagram illustrating example physical components of a computing device with which aspects of the disclosure may be practiced. FIG. 5 is a block diagram illustrating physical components (e.g., hardware) of a computing device 500 with which aspects of the disclosure may be practiced. The computing device components described below may be suitable for the computing devices described above, including device 104, as well as one or more devices discussed above with respect to FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may store the inner product generator 524 and related content model generator 526. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

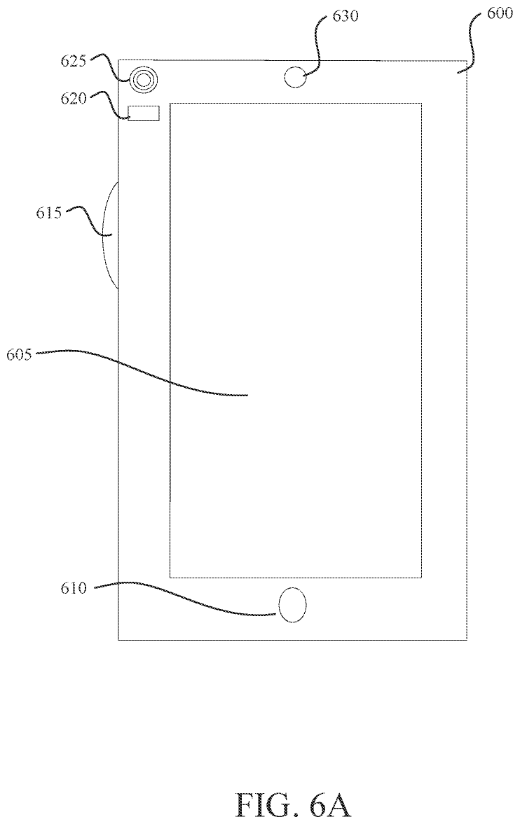

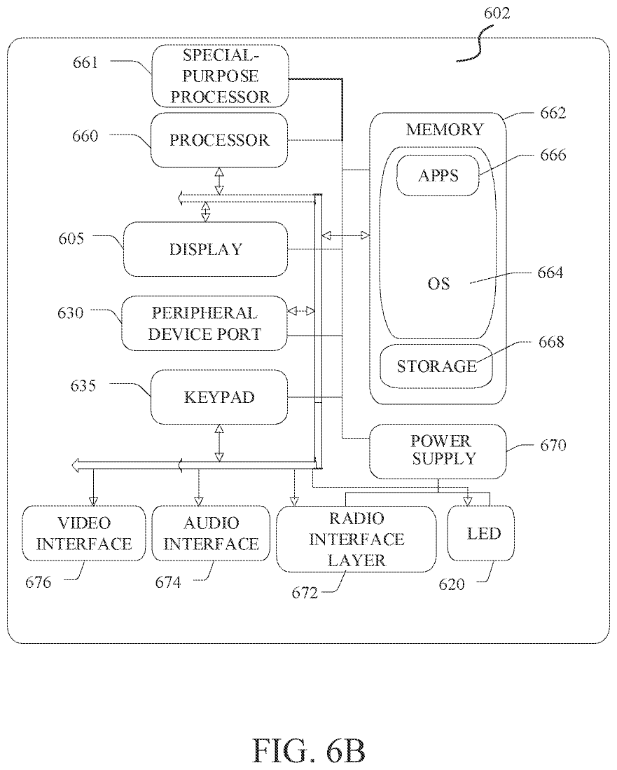

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld device having both input elements and output elements. The mobile computing device 600 typically includes a display 605 and an input button 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments. In another example, mobile computing device 600 may also include an optional keypad (not pictured), which may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein.

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

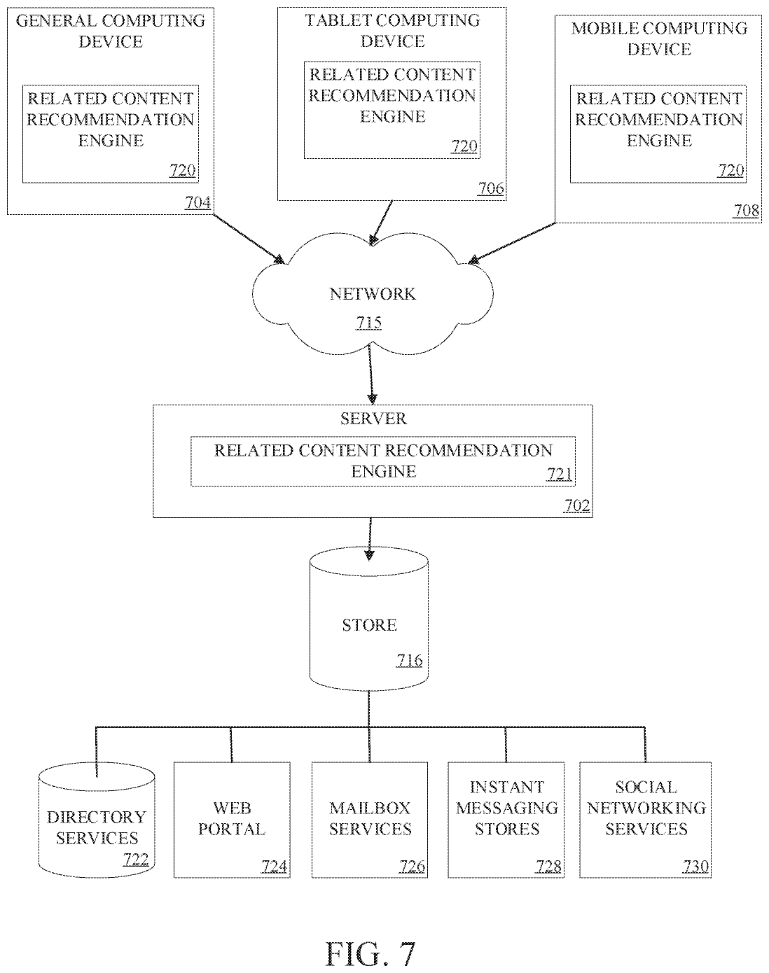

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730.

A related content recommendation engine 720 may be employed by a client that communicates with server device 702, and/or related content recommendation engine 721 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

In examples, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: obtaining a search query; generating a set of features for a search query tower and a related content tower, wherein the search query tower and the related content tower are each based on the obtained search query; training the search query tower and the related content tower; generating a trained feature vector for each of the search query tower and related content tower; training an inner product based on the search query trained feature vector and the related content trained feature vector; and generating, based on the trained inner product, a related content model for generating a set of recommended content based on a user search query. In an example, training the search query tower and related content tower further comprises utilizing a cascaded multilayer perceptron model comprised of multiple layers. In another example, the cascaded multilayer perceptron model layers comprises one or more of an expand layer or a bottleneck layer, and between the multilayer perceptron layers data scaling is performed. In a further example, data scaling comprises one or more of data standardization or data normalization including batch normalization, activation, and dropout. In yet another example, a skip connection is utilized between an initial input layer and another multilayer perceptron layer of the cascaded multilayer perceptron model. In a further still example, generating the set of features further comprises pre-processing the search query to generate a set of low-dimensional features using at least one of feature scaling, centering, or dimensionality reduction. In another example, the inner product is trained using self-supervised representation learning employing contrastive loss by tracking pairwise co-click signals associated with a plurality of search queries.

In another aspect, the technology relates to a method, comprising: receiving a search request including a search query for content; generating, using a related content model including a two-tower cascaded multilayer perceptron model, a set of recommended content associated with both the search query and an instance of content that is responsive to the search query; and providing, in response to the search request, the generated set of recommended content in association with the instance of content that is responsive to the search query. In an example, the instance of content is a first instance of content; and the related content model is trained using a set of co-click signals that includes: a positive pair between a second instance of content and a first instance of recommended content; and a negative pair between the second instance of content and a second instance of recommended content. In another example, a first tower of the two-tower cascaded multilayer perceptron model is associated with a first content type and a second tower of the two-tower cascaded multilayer perceptron model is associated with a second content type. In a further example, the first content type is a text content type associated with the search query and the second content type is an image content type. In yet another example, the search request further includes an indication of the instance of content that is responsive to the search query. In a further still example, the method further comprises comprising identifying the instance of content that is responsive to the search query.

In a further aspect, the technology relates to another method, comprising: obtaining a search query; generating a set of features for a search query tower and a related content tower, wherein the search query tower and the related content tower are each based on the obtained search query; training the search query tower and the related content tower; generating a trained feature vector for each of the search query tower and related content tower; training an inner product based on the search query trained feature vector and the related content trained feature vector; and generating, based on the trained inner product, a related content model for generating a set of recommended content based on a user search query. In an example, training the search query tower and related content tower further comprises utilizing a cascaded multilayer perceptron model comprised of multiple layers. In another example, the cascaded multilayer perceptron model layers comprises one or more of an expand layer or a bottleneck layer, and between the multilayer perceptron layers data scaling is performed. In a further example, data scaling comprises one or more of data standardization or data normalization including batch normalization, activation, and dropout. In yet another example, a skip connection is utilized between an initial input layer and another multilayer perceptron layer of the cascaded multilayer perceptron model. In a further still example, generating the set of features further comprises pre-processing the search query to generate a set of low-dimensional features using at least one of feature scaling, centering, or dimensionality reduction. In another example, the inner product is trained using self-supervised representation learning employing contrastive loss by tracking pairwise co-click signals associated with a plurality of search queries.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
obtaining a search query;
generating a set of features for a search query tower and a related content tower, wherein the search query tower and the related content tower are each based on the obtained search query;
training the search query tower and the related content tower;
generating a trained feature vector for each of the search query tower and related content tower;
training an inner product based on the search query trained feature vector and the related content trained feature vector; and
generating, based on the trained inner product, a related content model for generating a set of recommended content based on a user search query.

2. The system of claim 1, wherein training the search query tower and related content tower further comprises utilizing a cascaded multilayer perceptron model comprised of multiple layers.

3. The system of claim 2, wherein the cascaded multilayer perceptron model layers comprises one or more of an expand layer or a bottleneck layer, and between the multilayer perceptron layers data scaling is performed.

4. The system of claim 3, wherein data scaling comprises one or more of data standardization or data normalization including batch normalization, activation, and dropout.

5. The system of claim 2, wherein a skip connection is utilized between an initial input layer and another multilayer perceptron layer of the cascaded multilayer perceptron model.

6. The system of claim 1, wherein generating the set of features further comprises pre-processing the search query to generate a set of low-dimensional features using at least one of feature scaling, centering, or dimensionality reduction.

7. The system of claim 1, wherein the inner product is trained using self-supervised representation learning employing contrastive loss by tracking pairwise co-click signals associated with a plurality of search queries.

8. A method comprising:
receiving a search request including a search query for content;
generating, using a related content model including a two-tower cascaded multilayer perceptron model, a set of recommended content associated with both the search query and an instance of content that is responsive to the search query; and
providing, in response to the search request, the generated set of recommended content in association with the instance of content that is responsive to the search query.

9. The method of claim 8, wherein:
the instance of content is a first instance of content; and
the related content model is trained using a set of co-click signals that includes:
a positive pair between a second instance of content and a first instance of recommended content; and
a negative pair between the second instance of content and a second instance of recommended content.

10. The method of claim 8, wherein a first tower of the two-tower cascaded multilayer perceptron model is associated with a first content type and a second tower of the two-tower cascaded multilayer perceptron model is associated with a second content type.

11. The method of claim 10, wherein the first content type is a text content type associated with the search query and the second content type is an image content type.

12. The method of claim 8, wherein the search request further includes an indication of the instance of content that is responsive to the search query.

13. The method of claim 8, further comprising identifying the instance of content that is responsive to the search query.

14. A method comprising:
obtaining a search query;
generating a set of features for a search query tower and a related content tower, wherein the search query tower and the related content tower are each based on the obtained search query;
training the search query tower and the related content tower;
generating a trained feature vector for each of the search query tower and related content tower;
training an inner product based on the search query trained feature vector and the related content trained feature vector; and
generating, based on the trained inner product, a related content model for generating a set of recommended content based on a user search query.

15. The method of claim 14, wherein training the search query tower and related content tower further comprises utilizing a cascaded multilayer perceptron model comprised of multiple layers.

16. The method of claim 15, wherein the cascaded multilayer perceptron model layers comprises one or more of an expand layer or a bottleneck layer, and between the multilayer perceptron layers data scaling is performed.

17. The method of claim 16, wherein data scaling comprises one or more of data standardization or data normalization including batch normalization, activation, and dropout.

18. The method of claim 15, wherein a skip connection is utilized between an initial input layer and another multilayer perceptron layer of the cascaded multilayer perceptron model.

19. The method of claim 1, wherein generating the set of features further comprises pre-processing the search query to generate a set of low-dimensional features using at least one of feature scaling, centering, or dimensionality reduction.

20. The method of claim 14, wherein the inner product is trained using self-supervised representation learning employing contrastive loss by tracking pairwise co-click signals associated with a plurality of search queries.
